(19) United States
(12) Patent Application Publication
(10) Pub. No.: US 2010/0306468 A1
(43) Pub. Date: Dec. 2, 2010

(54) DISK ARRAY, AND DISK ARRAY CONTROL METHOD AND PROGRAM

(75) Inventor: Tomotaka SHIONOYA, Kokubunji (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/791,204

(22) Filed: Jun. 1, 2010

(30) Foreign Application Priority Data
Jun. 2, 2009 (JP) 2009-133176

(51) Int. Cl. G06F 12/00

(52) U.S. Cl. 711/114

(57) ABSTRACT

A data management section manages source data from a host apparatus by dividing the source data into a plurality of stripe structure data, and distributes and stores the plurality of stripe structure data in a plurality of storage devices having different capacity. Then, the data management section performs control for determining the length of the stripe structure data according to the capacity of each of the plurality of storage devices, and stores the stripe structure data of the same length in each of the storage devices. Further, the data management section manages, as a chunk structure, a data set configured by each one of the stripe structure data respectively stored in the plurality of storage devices. At this time, the source data is configured by a set of the chunk structures. The above contents are the same in RAID 0 and RAID 5.

### CLAIM OF PRIORITY

The present application claims priority from Japanese patent application JP 2009-133176 filed on Jun. 2, 2009, the content of which is hereby incorporated by reference into this application.

### BACKGROUND OF THE INVENTION

1. Field of the Invention

The present invention relates to a disk array, and a control method and program of the disk array. The present invention relates to, for example, a disk array which configures a virtual storage by a plurality of storage devices.

2. Background Art

In recent years, the amount of digital data and the capacity of hard disk drive tend to be increased. The increase of digital data increases the importance of data redundancy. On the other hand, the increase in the capacity of hard disk drive makes it possible to secure the increasing digital data, but increases the loss in the case of the crash of hard disk drive.

In such situations, a storage device of terabyte order has come to be installed even in the home. For the purpose of facilitating the maintenance of the storage device, the digital data redundancy methods, conventionally used in the large-scale server, have come to be generally applied to such storage device. A representative of such digital data redundancy methods is RAID (Redundant Arrays of Inexpensive Disks) as disclosed in, for example, “A case for redundant arrays of inexpensive disks (RAID)”, SIGMOD 1988.

A RAID is a system based on the premise that the capacity of all the disks is the same in any variation of the system. That is, at the time of disk crash in the RAID, it is desirable to prepare a disk having the same capacity as that of the disk used when the system is configured.

However, in many cases, due to the remarkable increase in the disk capacity in recent years, it has become difficult or a disadvantageous in terms of bit unit price to acquire, at the time of disk crash, the disk having the same capacity as the capacity used when the system is configured.

Therefore, at the time of disk crash, a case where the whole system is reconfigured, and a case where a large capacity disk, a part of which is made unusable, is used as a substitute small capacity disk are increased, so as to cause time or money loss. In order to cope with such problems, for example, JP Patent Publication (Kokai) No. 2002-99391 and JP Patent Publication (Kokai) No. 08-63298 describe methods by which, even when a disk array is configured by storage devices having a different capacity, the disk array can be constructed without lowering the capacity efficient rate.

However, even in any of the system according to JP Patent Publication (Kokai) No. 2002-99391 and JP Patent Publication (Kokai) No. 08-63298, there is a problem that as compared with the RAID, the parallel operation rate of the disks is lowered and thereby the performance is deteriorated. For example, according to the technique described in JP Patent Publication (Kokai) No. 2002-99391, since two or more small capacity disks are attached so as to be used as one large capacity disk, the disk in charge of a region storing no data is not used, and hence the parallel operation rate of the disks is lowered.

Further, in the technique described in JP Patent Publication (Kokai) No. 08-63298, all the disks are operated in parallel as long as the disk having the smallest capacity can store data, but there is a problem that the parallel operation rate of the disks is gradually lowered as the amount of stored data is increased.

Further, in the technique described in any one of JP Patent Publication (Kokai) No. 2002-99391 and JP Patent Publication (Kokai) No. 08-63298, the stripe structure length set in the respective disks is fixed, which is also a cause of the lowering of the speed. This is because a large capacity hard disk drive generally used as a storage device in the RAID has a feature that a disk having a larger capacity can perform read and write operations at higher speed, and hence a disk having a low read and write speed becomes an obstacle in read and write operations of fixed data length (chunk structure), so as to prevent the speed performance of the large capacity disk from being exhibited. That is, in the prior art, the high speed performance based on the disk parallel operation, which is a feature of the RAID, is sacrificed to improve the capacity efficient rate.

The present invention has been made in view of the above described circumstances. An object of the present invention is to improve the capacity efficient rate of a disk array configured by attaching storage devices (disk storages) having a different capacity, without sacrificing the high speed performance of the disk array.

### SUMMARY OF THE INVENTION

To this end, in a disk array according to the present invention, a data management section (configured by a CPU and a memory) manages a source data from a host apparatus by dividing the source data into a plurality of stripe structure data, and by distributing and storing the plurality of stripe structure data in a plurality of storage devices. Here, at least one of the plurality of storage devices has a capacity different from the capacity of the other storage devices. The data management section performs control for determining the length of the stripe data according to the capacity of each of the plurality of storage devices, and for storing the stripe data of the same length in each of the storage devices. Further, the data management section manages, as a chunk structure, a data set formed by each one of the stripe data which are respectively stored in the plurality of storage devices. At this time, the source data is formed by a set of the chunk structures. The above described configurations and operations are the same in both RAID 0 and RAID 5.

Here, when an access request is received from the host apparatus (in the case of RAID 0), the data management section first divides a request LBA (LBA in the virtual disk space) included in the access request by the length of the chunk structure to thereby calculate a head chunk structure which is the chunk structure including the position of the request LBA. Next, the data management section calculates an offset, which is a distance from the starting position of the head chunk structure to the request LBA, on the basis of the request LBA, the head chunk structure, and the stripe structure data length information included in the head chunk structure, so as to specify a storage device (access start storage device) which is to start to be accessed. Then, the data management section specifies an access start LBA (LBA in the real disk space) in the access start storage device on the basis of the offset and the head chunk structure position information indicating the ordinal number of the head chunk structure in the order of the chunk structures.

In the case of RAID 5, the data management section manages a set of the stripe data as a chunk structure, and performs control for: determining a storage device in charge of storing parity bits (storage device in charge of parity bits) on the basis of the information indicating the ordinal number of a target chunk structure in the order of the chunk structures; generating parity bits from the stripe data of the storage devices other than the storage device in charge of parity bits; storing only the parity bits in the storage device in charge of parity bits; and storing, in each of the storage devices other than the storage device in charge of parity bits, the stripe data of the length determined according to the capacity of each of the storage devices. At this time, when the process, in which each of the plurality of storage devices becomes in charge of parity bits once, is set as one cycle, the data management section performs management so that the total length of the stripe structure data other than the parity bits in all the chunk structures included in the one cycle is the same between the cycles.

When an access request is received from the host apparatus (in the case of RAID 5), the data management section first divides a request LBA (LBA in the virtual disk space) included in the access request by the total length of the stripe data in all the chunk structures included in one cycle, to thereby calculate the ordinal number of the cycle corresponding to the position of the request LBA. Next, the data management section calculates a first offset which is a distance from the head of the corresponding cycle to the request LBA. Then, on the basis of the first offset and the length information of each of the chunk structures included in the corresponding cycle, the data management section specifies a head chunk structure which is a chunk structure including the position of the request LBA. Further, on the basis of the request LBA, the head chunk structure, and the stripe structure data length information included in the head chunk structure, the data management section calculates a second offset which is a distance from the starting position of the head chunk structure to the request LBA, and thereby specifies a storage device (access start storage device) which is to start to be accessed. Finally, the data management section specifies an access start LBA (LBA in the real disk space) in the access start storage device on the basis of the chunk structure position information indicating the ordinal number of the head chunk structure in the order of the chunk structures, the information on the access start storage device, the stripe structure data length of the access start storage device, and the information on the number of times when the access start storage device has been in charge of parity bits.

Further, when at least one of the plurality of storage devices (storage device to be substituted, for example, crashed storage device) is substituted by a substitute storage device having a capacity larger than the capacity of the storage device to be substituted, the data management section stores the data of the storage device to be substituted in the substitute storage device. In this case, the data management section restores the data of the storage device to be substituted (crashed storage device) from the data stored in storage devices other than the storage device to be substituted, and stores the restored data in the substitute storage device.

Further, when there are storage devices having a capacity smaller than the capacity of the substitute storage device, among the storage devices (existing storage device) other than the storage device to be substituted, the data management section successively copies the data of the existing storage device having the capacity smaller than and closest to the capacity of the substitute storage device, into the substitute storage device, and then stores the data of the storage device to be substituted in the existing storage device having the capacity larger than and closest to the capacity of the storage device to be substituted.

The features of the present invention will be further elucidated hereinafter on the basis of exemplary embodiments for implementing the present invention, with reference to the drawings.

According to the present invention, the capacity efficient rate of a disk array configured by attaching storage devices (disk storages) having a different capacity can be improved without sacrificing the high speed performance of the disk array.

### BRIEF DESCRIPTION OF THE DRAWINGS

FIG. 1 is a diagram showing a schematic configuration of a disk array according to a first embodiment of the present invention.

FIG. 2 is a diagram showing a correspondence relationship between a real disk space of storage devices and a virtual disk space configured by the disk array in the first embodiment.

FIG. 3 is a flow chart for explaining (outline of) LBA conversion processing according to the first embodiment.

FIG. 4 is a flow chart for explaining processing for specifying a head chunk structure in the first embodiment.

FIG. 5 is a flow chart for explaining processing for specifying a storage device which is to start to be access in the first embodiment.

FIG. 6 is a flow chart for explaining processing for specifying an access start LBA in the storage device in the first embodiment.

FIG. 7 is a diagram showing a schematic configuration of a disk array according to a second embodiment.

FIG. 8 is a diagram showing a correspondence relationship between a real disk space of the storage devices and a virtual disk space constructed by the disk array in the second embodiment.

FIG. 9 is a flow chart for explaining processing for specifying a head chunk structure in the second embodiment.

FIG. 10 is a flow chart for explaining processing for specifying an access start LBA in the storage device in the second embodiment.

FIG. 11 is a flow chart for explaining processing for storing data in the disk array in the second embodiment.

FIG. 12 is a flow chart for explaining data restoration processing performed at the time of crash of the storage device in the second embodiment.

FIG. 13 is a diagram showing an example of application of the disk array.

### DESCRIPTION OF SYMBOLS

1: Disk array
2: Storage device
3: Host apparatus
20: Virtual storage device
25: Stripe structure
26: Parity bits

### DETAILED DESCRIPTION OF THE PREFERRED EMBODIMENTS

The present invention relates to a technique to improve the capacity efficient rate of storage devices attached to a disk array.

In the following, embodiments according to the present invention will be described with reference to accompanying drawings. It should be noted that the embodiments are only examples for implementing the present invention, and that the technical scope of the present invention is not limited by the embodiments. Further, in each of the accompanying drawings, common components are designated by the same reference numerals and characters.

### (1) First Embodiment

A first embodiment relates to a disk array using RAID 0.

### <Configuration of Disk Array>

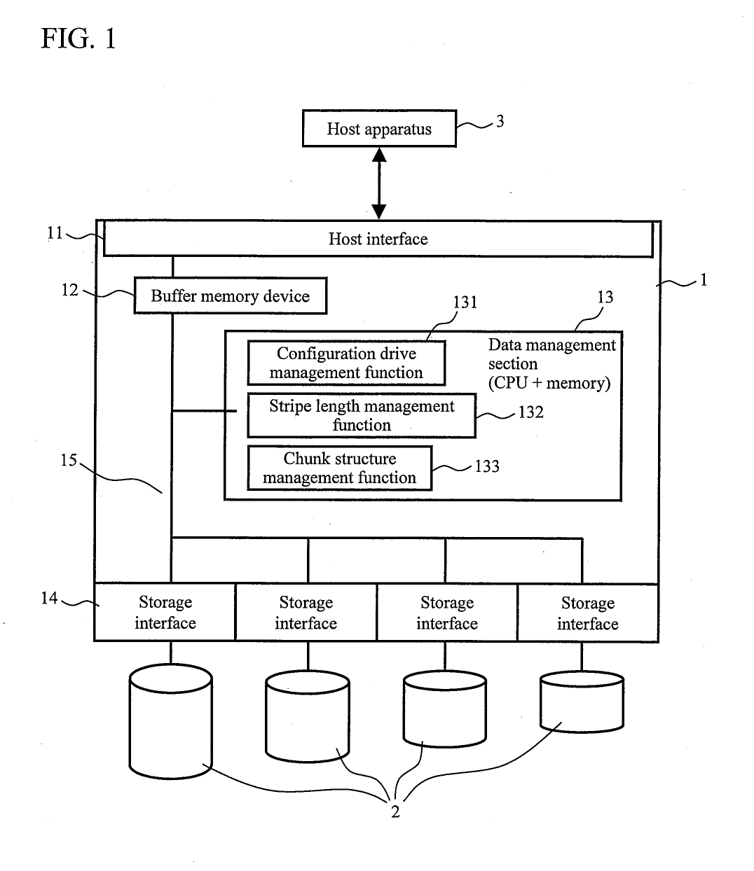

FIG. 1 is a diagram showing a schematic configuration of a disk array according to a first embodiment of the present invention. As shown in FIG. 1, a disk array 1 includes: a host interface 11 which performs communication with a host apparatus 3; a buffer memory device (buffer memory including cache memory) 12 which temporarily stores data; a data management section 13 which performs data management in the disk array; a plurality of storage interfaces 14 (four in the figure) which are used to attach storage devices 2; and a communication bus 15 which connects these components to each other and which transmits data, an instruction, and the like.

The host interface 11 may be a communication interface having an effective transfer rate in a range of about 500 Mbps, such as the interfaces of Universal Serial Bus and of IEEE 1394, but is preferably a communication interface having a transfer rate of about several Gbps, such as the interfaces of Gigabit Ethernet and of Fibre Channel. This is because a hard disk drive widely used as a large-scale storage device has a transfer rate of about 1 Gbps, and also some of solid-state disk storages, which have been spreading in recent years, include a disk storage having a reading speed close to 2 Gbps, and because when the host interface 11 having a low transfer rate is used for such hard disk drive or the disk storage, the host interface 11 becomes a bottleneck so as to prevent the reducing effect of the speed performance deterioration, according to the present invention, from being exhibited.

The buffer memory device 12 is a high-speed volatile memory, such as a Synchronous Dynamic Random Access Memory. In the present invention, the buffer memory device 12 temporarily stores a fixed amount of data from the host apparatus 3. When the amount of data stored in the buffer memory device 12 becomes sufficient to be distributed into each of the storage devices 2 which are respectively attached to the storage interfaces 14, the stored data are read by the data management section 13, so as to be stored in each of the storage devices 2.

The data management section 13 is configured by a memory and a CPU. The CPU executes each of management programs stored in the memory. Thereby, the CPU performs control for restoring data to be transferred to the host apparatus 3, and control for dividing data received from the host apparatus 3 so that the divided data are respectively stored in the storage devices 2 which are respectively attached to the storage interfaces 14.

The data management section 13 includes, as functions to be executed, a configuration drive management function 131 of managing information of each of the storage devices 2 respectively attached to the storage interfaces 14, a stripe structure length management function 132 of managing the length of the data storage unit (stripe structure 25) of each of the storage devices 2, and a chunk structure management function 133 of managing the data storage unit (chunk structure) of a virtual storage device 20 managed by the disk array 1.

The configuration drive management function 131 is a function of managing the number of the storage devices 2 respectively attached to the storage interfaces 14, and the capacity of each of the storage devices 2. More specifically, when each of the storage devices 2 is attached, the configuration drive management function 131 reads the property information to acquire the capacity information of each of the storage devices 2, and stores the capacity information, for example, on a table in a memory, in correspondence with the identification information of each of the storage devices 2.

The stripe length management function 132 has a function of determining the length of the stripe structure 25 stored in each of the storage devices 2, on the basis of the number and capacity information of the storage devices 2 managed by the configuration drive management function 131, and on the basis of the chunk structure size (which may be a default value) given by the user. The stripe structure length is given by the following expression.

Si=Sc×(Ci/C) (1)

Here, Si designates a stripe structure length for the storage device 2 attached to the i-th storage interface 14. Further, Sc designates the chunk structure length given by the user. Further, Ci designates the capacity of the storage device 2 attached to the i-th storage interface 14, and C designates the total capacity of all the storage devices 2 respectively attached to the storage interfaces 14. Note that Si is hereinafter referred to as the i-th stripe structure length.

When receiving a data storage instruction, the chunk structure management function 133 divides the chunk structure in the buffer memory device 12 into the stripe structures 25, and stores the divided stripe structures 25 in the storage devices 2, respectively. Further, the chunk structure management function 133 has a function of, when receiving a reading instruction, selecting suitable storage device 2 and an access start LBA in the selected storage device 2 from an LBA (Logical Blocking Address) included in the read request from the host apparatus 3.

The storage interface 14 is configured by a storage device interface, such as, for example, those represented by Serial AT Attachment, Information Versatile Disk for Removable usage, AT Attachment Packet Interface.

### <Data Distribution and Storage Method>

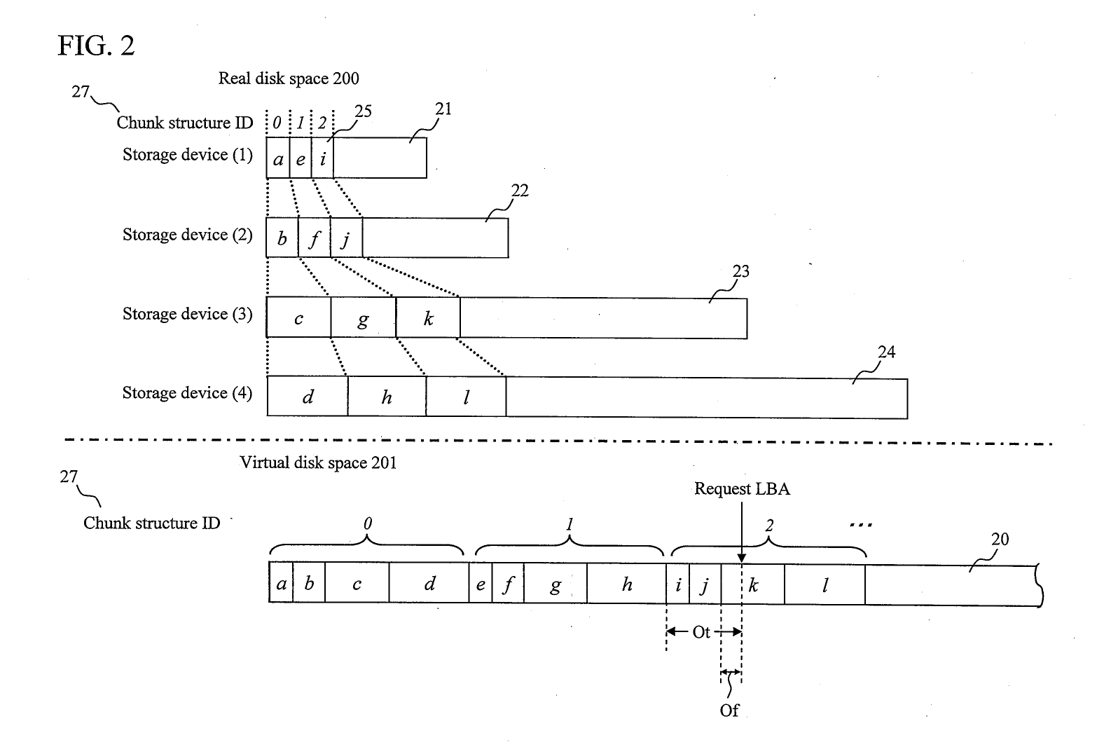

FIG. 2 is a diagram for explaining a data distribution and storage method according to the first embodiment of the present invention. In FIG. 2, the upper half of the figure divided by a broken-dotted line shows a data storage state (real disk space 200) in the real disk, and the lower half of the figure shows a data storage state (virtual disk space 201) in the virtual storage which can be used from the host apparatus 3.

It is assumed that in the real disk space 200, four storage devices 2 are attached, and the storage devices 2 of smaller capacity are attached in order from the smallest number of the storage interface 14. Here, the present invention need not necessarily be configured by only four storage devices 2. It should be noted that as long as the number of the storage devices 2 is three or more, any number of the storage devices 2 can be applied, and that the storage devises 2 can be applied even when they are not attached in ascending order or descending order of the capacity.

The chunk structure is divided into the stripe structures 25, so as to be distributed into the four disks. Here, it should be noted that a chunk structure ID 27 (0, 1, 2, . . . ) given to each of the chunk structures is assigned for convenience of explanation, and is not an essential element.

As described above, the size of each of the stripe structures 25 is determined by the capacity of each of the storage devices 2, and a smaller stripe structure 25 is assigned to a storage device 2 having a smaller capacity. With this feature, it is possible to prevent the lowering of the capacity efficient rate of a large capacity disk, which is caused due to the exhaustion of capacity of a small capacity disk, and which is caused in a conventional disk array using Raid.

Next, the virtual disk space 201 will be described. The host apparatus 3 is controlled so as to access to only one storage device (virtual storage) regardless of how many storage devices 2 are attached to the disk array 1.

In FIG. 2, the correspondence between the real disk space 200 and the stripe structures 25 in the virtual disk space 201 is shown by the alphabetic characters respectively assigned to the stripe structures 25 in the figure. The data respectively corresponding to the chunk structure IDs 27, each of which is assigned across the storage devices 2 in the real disk space 200, are continuously arranged in the virtual disk space 201, so that the stripe structures 25 are also aligned in the ascending order.

### <Access Request Processing>

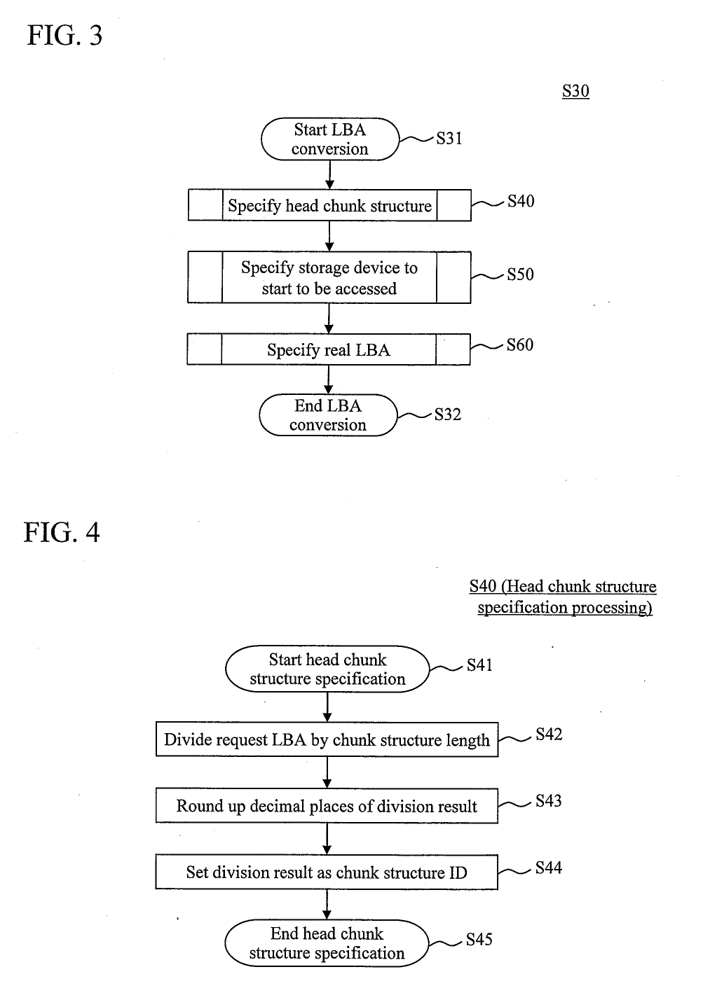

Then, the processing at the time when an access request is issued by the host apparatus 3 to the disk array 1 by using the LBA in the virtual storage is described. FIG. 3 is a flow chart (S30) for explaining the total processing of the disk array 1 which has received the access request from the host apparatus 3, that is, the processing until the virtual LBA (LBA in the virtual disk space) is converted to the real LBA (LBA in the real disk space).

First, on the basis of the virtual LBA instructed by the host apparatus 3, the disk array 1 specifies a head chunk structure by using the chunk structure management function 133 (S40). That is, the chunk structure of the virtual disk space, in which the virtual LBA is included, is specified.

Next, on the basis of the chunk structure ID 27 of the head chunk structure specified in step S40 (S50), the chunk structure management function 133 specifies the storage device 2 which is to start to be accessed.

Finally, the chunk structure management function 133 specifies an access start LBA (real LBA) of the storage device 2 specified in step S50 (S60).

With the above described processing procedure, the disk array 1 can realize the conversion of the request LBA from the host apparatus to the suitable real LBA of the storage device 2. In the following, each of the processing procedures S40, S50, and S60 will be described in detail.

### <Details of Specification Processing (S40) of Head Chunk Structure>

FIG. 4 is a flow chart for explaining the details of the processing (S40) to specify the head chunk structure ID 27 (position of head chunk structure). The position (chunk structure ID 27) of the head chunk structure can be obtained by dividing the request LBA by the chunk structure length. That is, when a function to round up decimal places is expressed as RU and when the chunk structure ID 27 is expressed as h (=h: 0, 1, 2, . . . ), the division operation is expressed as Expression (2). Expression (2) is expressed by the flow chart of FIG. 4.

h=RU(LBA/Sc) (2)<

### <Details of Access Start Storage Device Specification Processing (S50)>

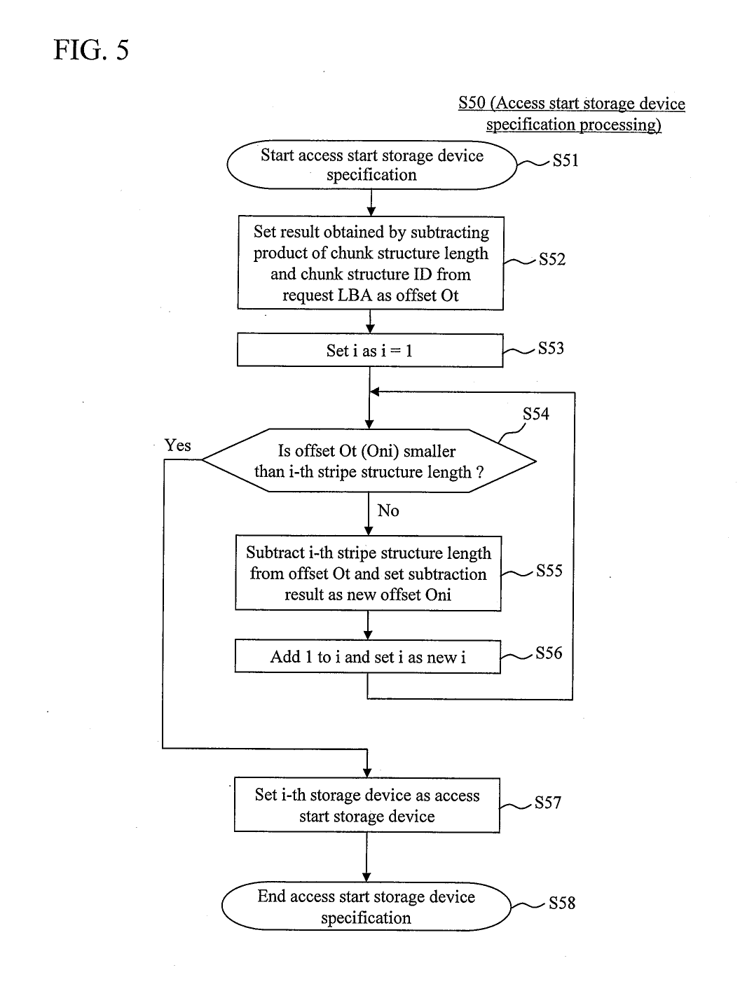

FIG. 5 is a flow chart for explaining the details of the processing (S50) to specify the storage device 2 which is to start to be accessed. The storage device 2 which is to start to be accessed can be specified by successively subtracting each of the stripe structure lengths from the difference between the request LBA (virtual LBA in the virtual disk space) and the total sum of the chunk structure lengths up to the head chunk structure specified in S40. This operation procedure is expressed by the flow chart of FIG. 5. In the following, the difference between the request LBA and the total sum of the chunk structure lengths up to the head chunk structure is referred to as offset Ot.

First, the chunk structure management function 133 calculates the offset Ot by using the formula (3) described below (S52). That is, the distance from the LBA of the head chunk structure to the request LBA can be obtained by the calculation (see FIG. 2).

Ot=LBA−Sc×h (3)

Then, the chunk structure management function 133 subtracts, from the offset Ot, the stripe structure length of each of the storage devices 2, which length is managed by the stripe length management function 132 (from S53 to S56). Then, the chunk structure management function 133 specifies the access start storage device 2 when detecting that subtraction result becomes negative (S57). The details of the processing will be described below.

First, the chunk structure management function 133 sets the disk number i to 1 (S53), and compares the offset Ot with the i-th stripe structure length Si (S54).

When the offset Ot is smaller than the i-th stripe structure length Si (Yes in S54), the chunk structure management function 133 specifies the i-th storage device 2 as the access start storage device 2 (S57), and sets the offset Ot at this time as the offset Of.

On the other hand, when the offset Ot is larger than the i-th stripe structure length Si (No in S54), the chunk structure management function 133 subtracts the i-th stripe structure length Si from the offset Ot, and sets the subtraction result as the new offset Oni (S55).

Then, the chunk structure management function 133 adds 1 to i (S56), to again perform the processing from the comparison with the stripe structure length Si on the basis of the newly set i and Oni (shift to S54), and finally calculates the offset Of. Note that the offset Of obtained by the access start storage device 2 specification processing (S50) is also used by real LBA specification processing (S60) and hence is stored in the buffer memory device 12.

### <Details of Real LBA Specification Processing (S60)>

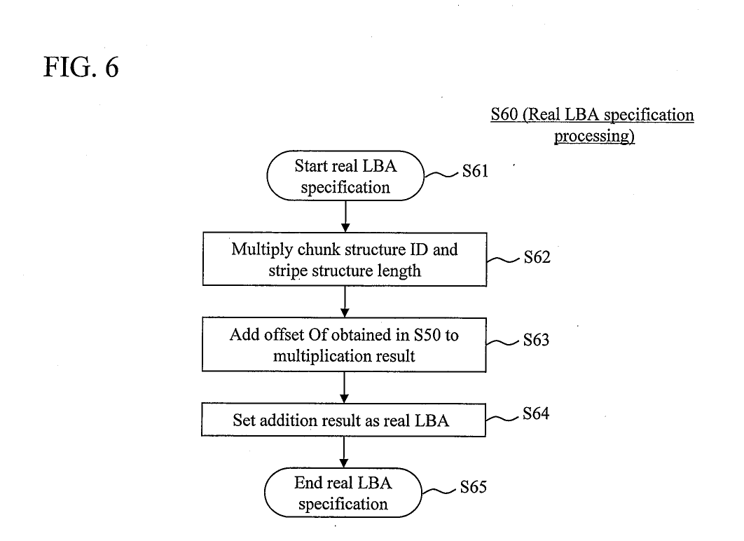

FIG. 6 is a flow chart for explaining the details of the specification processing (S60) of the LBA (real LBA) which is to actually start to be accessed on the storage device 2.

By use of the offset Of (offset obtained by subtracting the stripe structure length from Ot) acquired in the storage device specification processing (S50), the i-th stripe structure length Si, and the chunk structure ID 27 (=h), the chunk structure management function 133 can easily specify the start real LBA by Expression (4).

Start LBA=h×Si+Of (4)

The flow chart of FIG. 6 shows the calculation procedure of Expression (4). Thereafter, the stripe length management function 132 can realize the access to the virtual disk space 201 from the host apparatus 3 by outputting each of the stripe structures in order from the i-th storage device 2.

Note that since the above LBA conversion procedure eliminates the need to store the correspondence between the virtual LBA space and the real LBA space in a table format, and the like, it is possible to improve the capacity efficient rate without sacrificing the high speed performance even in a device not having abundant memory. However, in the case where hardware resources, such as memory, are sufficiently available, it is possible to increase the processing speed by providing the above described correspondence table.

### (2) Second Embodiment

The first embodiment does not have resistance against a crash of the storage device 2. Thus, in the present embodiment, RAID 5 is used to realize the crash resistance in the disk array 1.

### <Configuration of Disk Array>

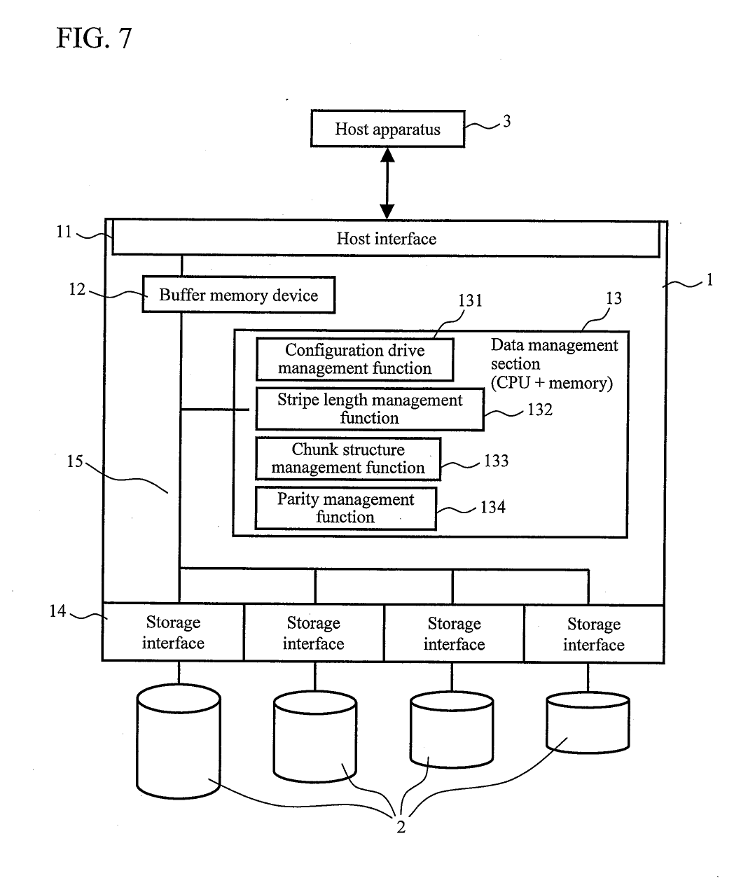

FIG. 7 is a diagram showing a schematic configuration of a disk array according to a second embodiment of the present invention. The disk array 1 includes: the host interface 11 which performs communication with the host apparatus 3; the buffer memory device (buffer memory including cache memory) 12 which temporarily stores data; the data management section 13 which performs management of data in the disk array 1; the plurality of storage interfaces 14 (four in the figure) which are used to attach the storage devices 2; and the communication bus 15 which connects these components to each other and which transmits data, an instruction, and the like.

A parity management function 134 has a function of generating, even when any one of the stripe structures 25 configuring the chunk structure is lost, parity bits 26 used to restore the lost stripe structure 25 from the remaining the stripe structures 25, and of restoring the lost stripe structure 25 from the remaining stripe structure 25 and the parity bits 26. The parity bits 26 are generally generated by taking the exclusive OR of the respective stripe structures 25. Although exclusive OR is also used in the present embodiment, the length of the stripe structures 25 is not the same in the chunk structure, and hence processing to unify the length of the stripe structures 25 is needed. Specifically, 0 is suitably added to the higher order portion of a stripe structure 25 having a length smaller than the length of a largest stripe structure 25, to make the length of each of the stripe structures 25 equal to the length of the largest stripe structure 25, and then the parity bits 26 are generated by taking Exclusive-OR of the respective stripe structures 25. For example, when one stripe structure is 01 and the other stripe structure is 0110, the former is set as 0001, so that the length of the stripe structure is made uniform.

Here, when a function to select a maximum from a plurality of candidates is expressed as max, the length Sp of the parity bits 26 is given by Expression (5).

Sp=Sc×(max(Ci)/C)=max(Si) (5)

That is, the parity length becomes equal to the length of the stripe structure of the storage device 2 having the maximum capacity.

When storing data, the chunk structure management function 133 determines the storage device 2 in which the parity bits 26 are to be stored, and divides the chunk structure in the buffer memory device into the stripe structures 25, so as to store the stripe structures 25 in the storage devices 2. On the other hand, when reading data, the chunk structure management function 133 generates the chunk structure by combining the stripe structures 25, while when restoring data, the chunk structure management function 133 restores the chunk structure on the basis of the stripe structures 25 and the parity bits 26. Further, the chunk structure management function 133 has a function of selecting a suitable storage device 2 and an access start LBA (real LBA) in the suitable storage device 2 from the LBA (Logical Blocking Address) included in the request from the host apparatus 3.

### <Data Distribution and Storage Method>

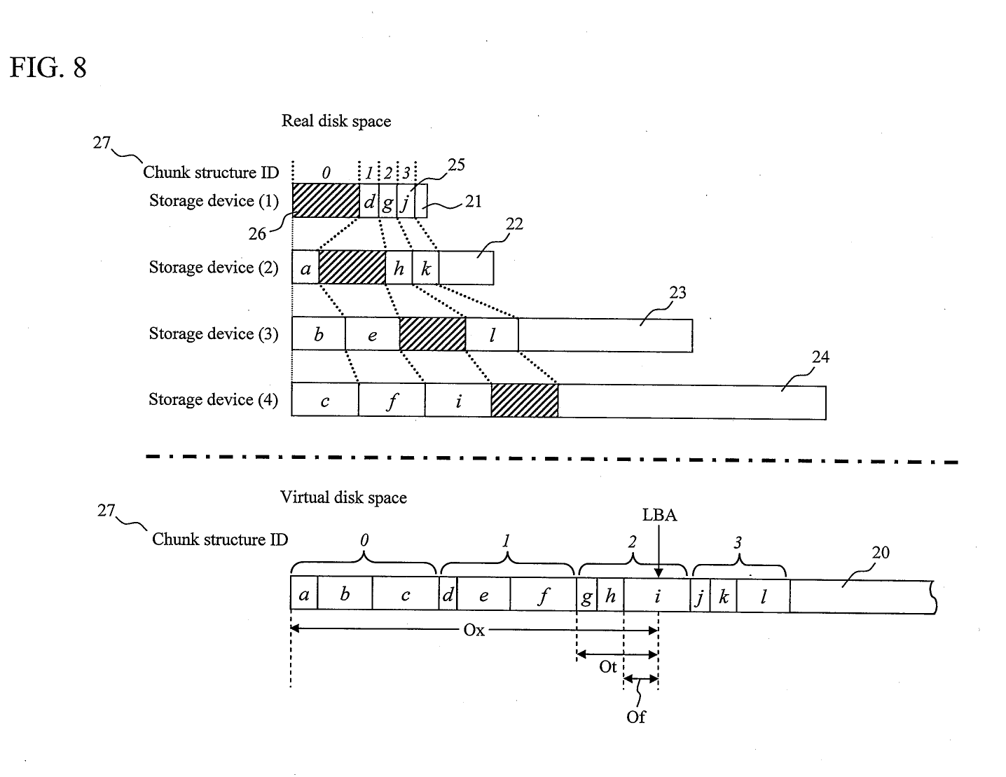

FIG. 8 is a diagram for explaining the data distribution and storage method according to the second embodiment. Also in the present embodiment, it is assumed that in the real disk space 200, four storage devices 2 are attached, and the storage devices 2 of smaller capacity are attached in order from the smallest number of the storage interface 14.

In the second embodiment, the chunk structure is divided into the stripe structures 25 and parity bits 26, so as to be distributed into four disks. As can be seen from FIG. 8, the length of each the chunk structures in the second embodiment is not the same unlike the first embodiment. However, the total length of the chunk structures for one cycle (during which the parity bits 26 are arranged in each of the storage devices 2 once) is fixed. That is, in the example of FIG. 8, the total length of the chunk structures of the chunk structure IDs from 0 to 3, is set equal to the total length of the chunk structures of the subsequent cycles (for example, the chunk structure IDs from 4 to 7).

The storage device 2 (parity drive) which stores the parity bits 26 is determined by the number i (parity drive number) calculated by using the chunk structure ID 27 (=h: 0, 1, 2, . . . ), the number of disks (=d) attached to the disk array 1, and a modulo operator (=%).

i=(h%d)+1 (6)

Unlike the first embodiment, the parity bits 26 exist in the second embodiment. As described above, the parity length Sp is determined by the disk capacity of the storage device 2 having the largest capacity among the storage devices configuring the disk array 1. Therefore, each time the storage device which stores the parity bits is changed, the chunk structure length Sc is changed. When the chunk structure length in the case where the i-th storage device 2 stores the parity bits 26 is set as Sci, Sci is expressed as Expression (7). Note that Si designates the stripe structure length of the i-th storage device 2.

Sci=Σ(Sk)−Si(k=1 to d) (7)

Hereinafter, Sci is referred to as the i-th chunk structure length.

Also in the second aspect, the chunk structure ID 27 is a number provided for the sake of convenience of explanation, and needs to be calculated from the LBA (virtual LBA) included in the request of the host apparatus 3. This calculation method will be described below in the explanation of the virtual disk space 201.

The virtual disk space 201 will be described with reference to FIG. 8. The host apparatus 3 is controlled to access to only one storage (virtual storage) device irrespective of how many storage devices 2 are attached to the disk array 1.

The correspondence of the stripe structures 25 between the real disk space 200 and the virtual disk space 201 is designated by the alphabetic characters assigned to the stripe structures 25 in FIG. 8.

### <Access Request Processing>

The whole processing performed by the disk array 1 which has received an access request from the host apparatus 3, that is, the processing until the virtual LBA (LBA in the virtual disk space) is converted to the real LBA (LBA in the real disk space) is the same as the processing shown in FIG. 3 (S30).

The existence of the parity bits 26 is hidden for the host apparatus 3, and only the stripe structures 25, which are divided portions of the real data, can be accessed by the host apparatus 3. However, the parity bits 26 exist in the real disk space 200, and hence the LBA conversion processing (S30) in consideration of the existence of the parity bits 26 is necessary in the access to the disk array 1. Therefore, processing in S40 and processing in S60 are respectively performed as follows. Note that the specification processing (S50) of the storage device 2 is the same as the processing (FIG. 5) in the first embodiment.

### <Details of Head Chunk Structure Specification Processing (S40)>

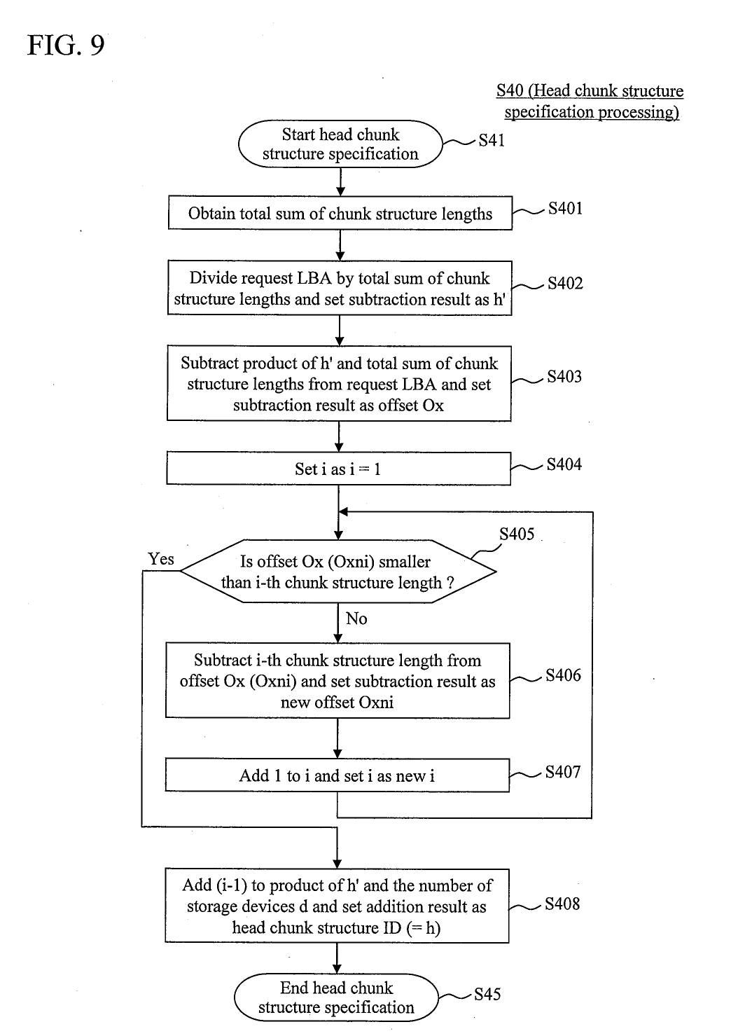

FIG. 9 is a flow chart for explaining the details of the head chunk structure specification processing according to the second embodiment. As already described, the chunk structure length Sc is not fixed in the second embodiment. Therefore, the chunk structure ID 27 (chunk structure position) cannot be specified by the division of the LBA by the chunk structure length, as in the first embodiment. Thus, the following processing is performed.

The chunk structure management function 133 divides the virtual LBA by the total sum (=SC: length per one cycle) of chunk structure lengths (=Sc), so as to specify the position of the virtual LBA at the accuracy (resolution) of the number (=d) of the disks. The total sum (=SC) of chunk structure lengths is expressed by Expression (8) by using the chunk structure length (=Sci) and the number (=d) of the storage devices 2. First, the total sum SC of the chunk structure lengths is calculated according to Expression (8) (S401).

SC=ΣSci(i=1 to d) (8)

By using SC calculated in S401, the temporary chunk structure ID (=h′) can be expressed as Expression (9). According to Expression (9), the temporary chunk structure ID, that is, the approximate position of the virtual LBA is specified (S402).

h′=RU(LBA/SC) (9)

Then, the chunk structure management function 133 subtracts the product of the total sum (=SC) of the chunk structure lengths and the temporary chunk structure ID (=h′) from the request LBA, and sets the subtraction result as the offset Ox (S403).

In the subsequent process, by successively subtracting each of chunk structure lengths Sci from the offset Ox, the chunk structure management function 133 calculates, as follows, the position of the chunk structure (head chunk structure) in which the chunk structure ID 27 (=h), that is, the LBA is included.

First, the chunk structure management function 133 sets the variable i to 1 (S404), and compares the offset Ox with the i-th chunk structure length Sci (S405). When the offset Ox is smaller than the i-th chunk structure length Sci (Yes in S405), the chunk structure management function 133 multiplies the temporary chunk structure ID (=h′) calculated in step S403 by the number of storage devices (=d), as expressed by Expression (10), and sets the multiplication result added with (i−1) as the head chunk structure ID27 (=h) (S408). Note that the offset Ox in this case is expressed as the offset Ot.

h=h′×d+(i−1) (10)

On the other hand, when the offset Ox is larger than the i-th chunk structure length Sci (No in S407), the chunk structure management function 133 subtracts the chunk structure length Sci from the offset Ox, and sets the subtraction result as the new offset Oxni (S406).

Then, the chunk structure management function 133 adds 1 to i (S407). Then, on the basis of the new i and the new offset Oxni, the chunk structure management function 133 again performs the processing from the processing to compare the offset Oxni with the chunk structure length Sci (the process is shifted to S405).

The above head chunk structure specification processing (S40) uses the same algorithm as the access start storage device specification processing (S50) in the first embodiment. Therefore, the software or the operation circuit can be reused, and hence the cost can be reduced even when the re-configuration from RAID 0 to RAID 5 is performed.

### <Details of Real LBA Specification Processing (S60)>

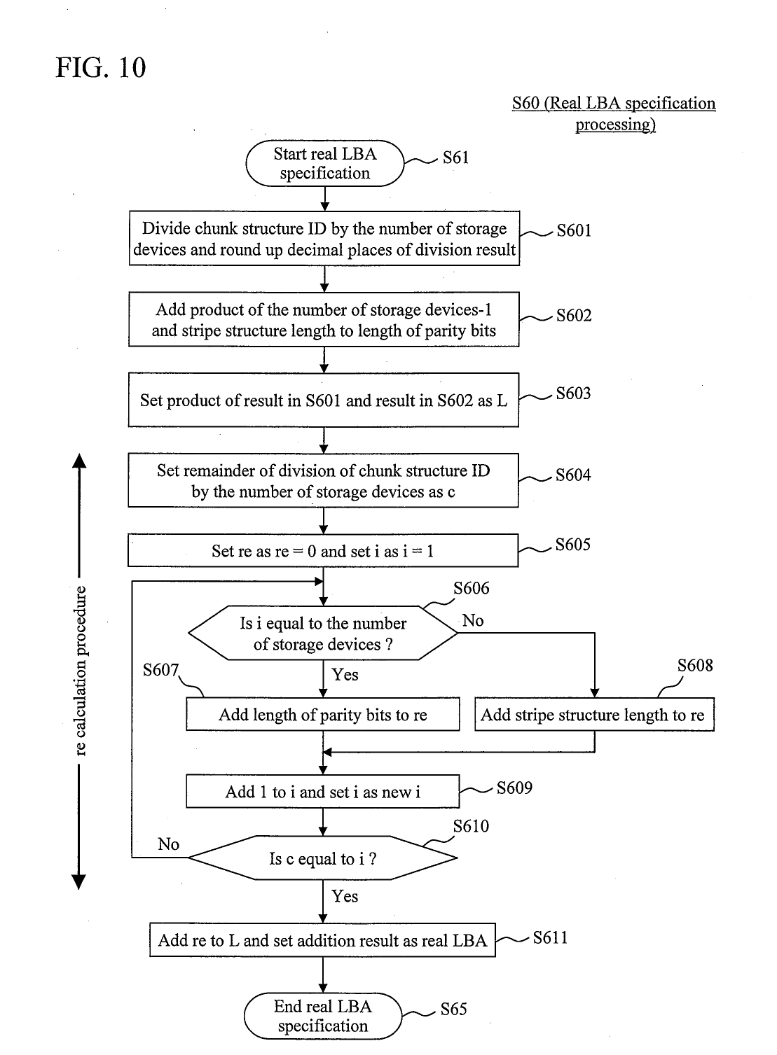

FIG. 10 is a flow chart for explaining the details of the specification processing (S60) of the access start LBA (real LBA) in the second embodiment.

The access start LBA is expressed by Expression (11) by using the stripe structure (=Si) and the chunk structure ID 27 (=h).

Start LBA=RU(h/d)×((d−1)×Si+Sp)+re (11)

Here, re is a correction term for taking the parity bits 26 into consideration. The term re is set to the parity length when the specified storage device (chunk structure) is in charge of the parity bits 26. The term re is set to a value obtained by adding together the stripe structure lengths a suitable number of times when the specified storage device 2 (chunk structure) is not in charge of the parity bits 26.

In the processing from S601 to S603, L=RU(h/d)×((d−1)−Si+Sp) is calculated.

In the following, the method to calculate the term re will be described in detail according to the processing from S604 to S610.

First, the chunk structure management function 133 calculates a remainder (=c) by dividing the chunk structure ID 27 (=h) by the number of disks (=d) (S604).

Further, the chunk structure management function 133 sets the correction term re to 0, and sets the variable i to 1 (S605). Then, the chunk structure management function 133 checks whether or not i is equal to the number of the disk storage, that is, whether or not the storage disk is in charge of parity bits (S606).

When i is equal to the number of the storage device (Yes in S606), the chunk structure management function 133 adds the parity length Sp to re (S607). On the other hand, when i is not equal to the number of the storage device (No in S606), the chunk structure management function 133 adds the stripe structure length S to re (S608).

Then, the chunk structure management function 133 updates re and then adds 1 to i (S609). Thereafter, the chunk structure management function 133 compares c with i (S610). When c is equal to i (Yes in S610), the chunk structure management function 133 adds re to the value of L, and is set the addition result as the real LBA, so as to end the processing. On the other hand, when c is not equal to i (No in S610), the chunk structure management function 133 again perform the processing from the processing (S606) to compare i with the number of the storage device.

When the subsequent processing is successively performed from the i-th storage device 2 in a repeating manner similarly to the first embodiment, the host apparatus 3 can access virtual disk space. Note that in a device having abundant memory, the correspondence between the storage device 2 corresponding to the request LBA and the real LBA may be stored in a table format, and the like, in order to increase the processing speed.

### <Data Storage Processing>

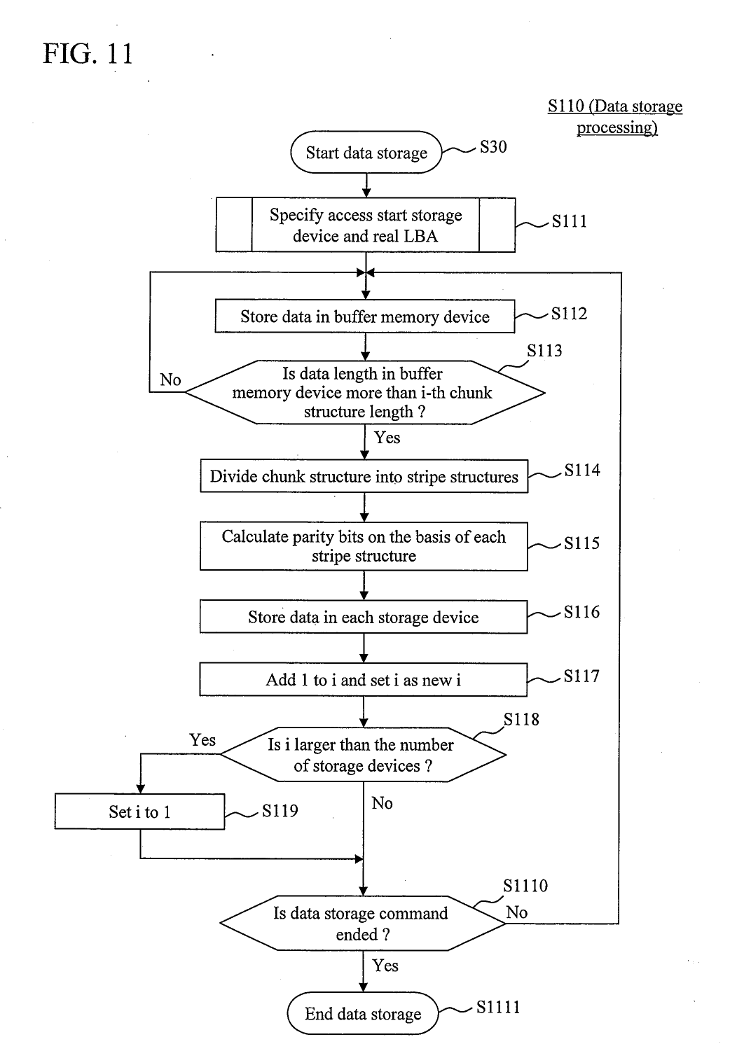

FIG. 11 is a flow chart for explaining the data storage processing (S110) when a data write request is issued from the host apparatus 3.

First, by using the LBA conversion processing (S30), the disk array 1 specifies the storage device 2 which is to start to be accessed, and the access start LBA (real LBA) in the storage device 2.

Then, the chunk structure management function 133 accumulates, in the buffer memory device 12, the data sent from the host apparatus 3 until the accumulated data size exceeds the i-th chunk structure length Sci (S112 and S113). At the time when the accumulated data size reaches Sci (Yes in S113), the chunk structure management function 133 divides the data accumulated in the buffer memory device into the stripe structures 25 (S114).

Subsequently, the parity management function 134 generates the parity bits 26 on the basis of the divided stripe structures 25 (S115). Then, the chunk structure management function 133 stores the parity bits 26 generated in S115 in the i-th storage device 2, and stores the divided stripes 25 in the other storage devices 2, respectively (S116).

After the storage processing, in order to change the storage device 2 in charge of parity bits 26 (drive), the chunk structure management function 133 updates i by adding 1 to i (S117). At this time, when i exceeds the number of disks (4 in the present embodiment), the chunk structure management function 133 returns i to 1 (S118 and 119).

The chunk structure management function 133 completes the data storage processing (S1110 and S1111) by repeating the above described processing until the end of the data storage request from the host apparatus 3.

### <Data Restoration Processing>

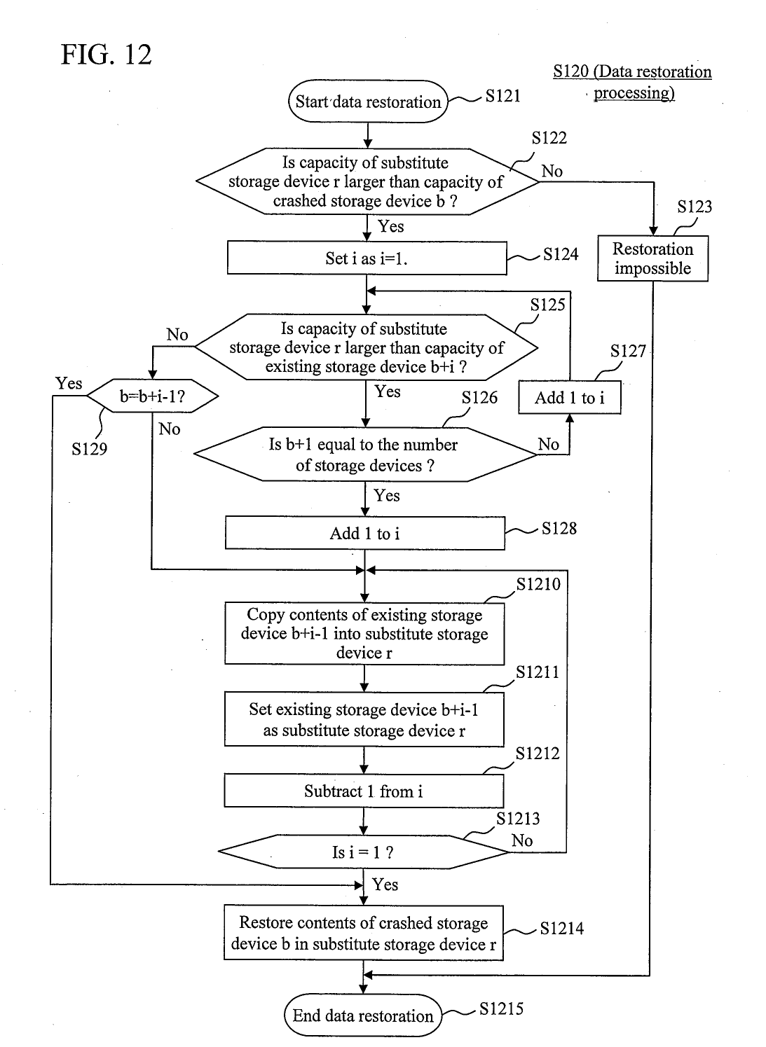

FIG. 12 is a flow chart for explaining the data restoration processing to cope with the case where the storage device 2 is crashed. The data restoration processing is processing by which the storage device r inserted as a substitute is made to exhibit its performance as much as possible so as to improve the performance of the entire system. To this end, different restoration processing is performed according to the capacity of the inserted storage device r. Here, the description is given by taking “crash” as an example. However, the case where the storage device is not crashed but is only replaced is assumed to be included.

First, the disk array 1 compares the capacity of the crashed storage device b with the capacity of the inserted substitute storage device r by using the configuration drive management function 131 (S122). When the capacity of the substitute storage device r is smaller than the capacity of the crashed storage device b (No in S122), the configuration drive management function 131 determines that the data restoration is impossible, and ends the processing without restoring the data (S123 and S1215).

On the other hand, when the capacity of the substitute storage device r is larger than the capacity of the crashed storage device b (Yes in S122), the configuration drive management function 131 is set i as i=1 (S124), and compares the capacity of the substitute storage device r with the capacity of the storage device b+i (storage device 2 having the capacity larger than and closest to the capacity of the crashed storage device) (S125). When the capacity of the substitute storage device r is larger than the capacity of the storage device b+i (Yes in S125), and when (b+i) is not equal to the number of storage devices (No in S126), the configuration drive management function 131 adds 1 to i (S127), and compares the capacity of the substitute storage device r with the capacity of the storage device b+i (storage device 2 having the capacity larger than and closest to the capacity of the storage device b+i−1) (S125). When (b+i) is equal to the number of storage devices, that is, when the substitute storage device r has the largest capacity among the storage devices 2 configuring the disk array 1 (Yes in S126), the process is shifted to S128, and 1 is added to i.

When a storage device 2 having a capacity larger than the capacity of the substitute storage device r exists, the configuration drive management function 131 determines whether or not the number b of the crashed storage device is equal to (b+i−1). When the number b of the crashed storage device is equal to (b+i−1), that is, when there is no existing storage device having a capacity smaller than the capacity of the substitute storage device r, the process is shifted to S1214. When b is not equal to (b+i−1) (when b<b+i−1), that is, when although the substitute storage device r is not the storage device having the largest capacity, there is an existing storage device having a capacity smaller than the capacity of the substitute storage device r, the process is shifted to S1210.

When although the substitute storage device r is not the storage device having the largest capacity, there is an existing storage device having a capacity smaller than the capacity of the substitute storage device r, or when although the substitute storage device r is found to be the storage device having the largest capacity, the configuration drive management function 131 copies the contents of the finally compared storage device (storage device number=b+i−1) into the substitute storage device r (S1210).

Subsequently, the configuration drive management function 131 copies the contents of the storage device having a capacity smaller than and closest to the capacity of the finally compared storage device 2 into the finally compared storage device, and repeats this copy processing until the copy processing returns to the first compared storage device 2. Specifically, the configuration drive management function 131 sets the storage device b+i−1 as the new substitute storage device r, and then subtracts 1 from i (S1212), to repeat the processing (to copy the contents of the storage device b+i−1 into the substitute storage device r) until i becomes 1 (S1210, S1211, S1212, and S1213).

Finally, the configuration drive management function 131 restores the contents of the crashed storage device b in the storage device selected as the substitute storage device r, so as to complete the data restoration processing (S1214 and S1215).

The above described data restoration processing is featured in that the order of the stripe size Si is also equal to the order of the capacity of the storage device 2 after the restoration. As a result, a storage device 2 having a larger capacity has a larger amount of data, so that the performance is optimized. Further, when the hard disk drive is used as the storage device 2, the storage device having a larger capacity has higher speed, and hence the read/write performance is also optimized.

### (3) Specific Example of LBA Conversion Processing

In the following, specific examples of the LBA conversion processing for data access will be described according the second embodiment.

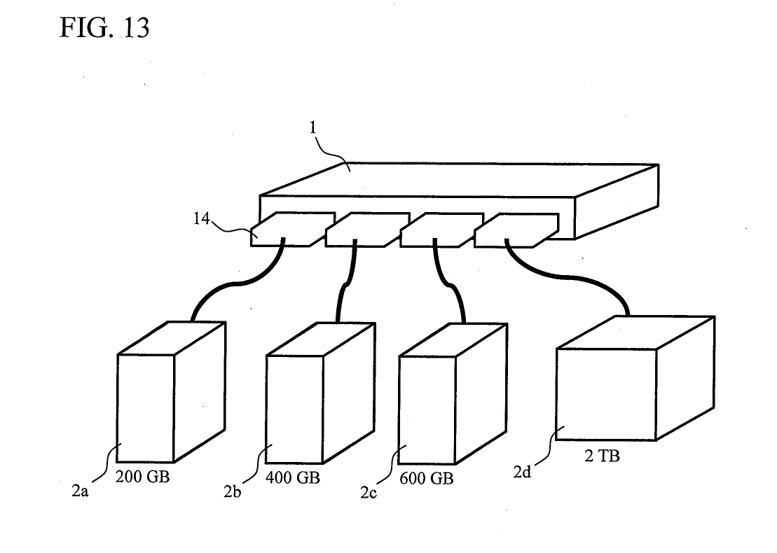

FIG. 13 is a diagram showing an example of the attachment configuration between the disk array 1 and the storage device 2. Four external storage devices 2a, 2b, 2c and 2d are attached to the disk array 1 by USB interfaces 14. The kind of external storage device 2 may be a type, for example, a single storage device or a disk array 1 configured by a plurality of storage devices.

It is assumed that the capacity of the storage devices 2a, 2b, 2c and 2d are 200 GB, 400 GB, 600 GB and 2 TB (=2000 GB), respectively, and that the chunk structure length Sc specified by the user is 128 kB. In this specific example, the LBA conversion procedure at the time when the data access is performed from the LBA of No. 10,000,000 in the virtual disk space of the disk array 1 will be described.

First, the stripe structure length Si and Sp stored in each of the storage devices 2 are calculated by using the stripe length management function 132 as follows.

S1:8 kB(128 kB×200/3200)

S2:16 kB(128 kB×400/3200)

S3:24 kB(128 kB×600/3200)

S4:80 kB(128 kB×2000/3200)

Sp:80 kB(=S4)

Here, it should be noted that the prefix k on the computer expresses 1024 times.

### <Access Start Chunk Structure Specification Processing (S40)>

The access start chunk structure is specified according to the head chunk structure specification processing (FIG. 9). The chunk structure length Sci and the total chunk structure length SC are as follows (S401).

Sc1: 200 kB

Sc2: 192 kB

Sc3: 184 kB

Sc4: 128 kB

SC: 704 kB

On the basis of the SC, the request LBA, and the number of disks, the temporary chunk structure ID (=h′) is calculated as follows (S402).

h′=RU(10000000/(704×1024))=13

It should be noted that since the total chunk structure length is used for the division, the accuracy (resolution) of h′ is about d, that is, 4 times.

Further, the offset Ox used to specify the access start chunk structure ID (=h) is obtained as follows.

Ox=10000000−(13×704×1024)=628352

From the chunk structure length Sc1, the chunk structure length Sci is successively compared with the offset Ot(On), so as to subtracted from the offset (S405, 5406, and S407). The offset finally obtained is set as Of.

628352−200×1024=423552(Ox−Sc1=Oxn1)

423552−192×1024=226944(Oxn1−Sc2=Oxn2)

226944−184×1024=38528(Oxn2−Sc3=Oxn3)

38528<128×1024(as a result of comparison between On3 and Sc4, it is set as 38528=Ot)

Therefore, the access start chunk structure ID (=h) can be obtained as follows (S408).

h=h′×d+i−1=13×4+4−1=55

### <Access Start Storage Device Specification Processing (S60)>

The access start storage device is specified in such a manner that the stripe structure length Si is successively compared with the offset Ot, so as to be subtracted from the offset (S54, S55, and S56).

38528−8×1024(Ot−S1=On1)

30336−16×1024(On1−S2=On2)

13952<24×1024(as a result of comparison between On2 and S3, it is set as 13952=Of)

Therefore, it is specified that the number i of the access start storage device is 3.

### <Specification of Access Start LBA>

The access start LBA is specified according to the access start LBA specification processing (FIG. 10). First, by using the stripe structure length S3, the chunk structure ID (=h), and the number of disks (=d), Expression: Start LBA−re=L is calculated as follows (S601 to S603).

Start LBA−re=RU(h/d)×((d−1)×Si+Sp)=2023424

Next, re is calculated by using the offset Of obtained in S54.

Since the chunk structure ID in this specific example is 55, the remainder after the division by the number of disks is 3. Further, the third storage device (FIG. 13) stores the parity bits in the third stripe structure thereof. Thus, in the projection from the virtual LBA space to the real LBA space, the third storage device stores data two times and stores the parity bits one time. That is, re can be calculated as follows.

re=Of+2×S3+Sp=13952+2×24×1024+80×1024=145024

Therefore, the access start LBA in the storage device 2c is obtained as follows.

Start LBA=2023424+145024=2168448

In the subsequent processing, while the stripe structure storing the parity bits is skipped, the stripe structures are respectively read from the respective storage devices and connected together so as to be outputted. Thereby, the data access to the virtual disk space from the host apparatus 3 is realized.

Note that the access to the actual storage device 2 is not performed by the byte unit but commonly performed by a larger unit referred to as a block or a sector. Also in that case, the algorithm according to the present invention can continue to be applied as it is only by changing the base unit of the algorithm from the byte to the block or the sector, and hence the base unit used in the access does not become an obstacle to the application of the present invention.

### (4) Specific Example of Crash Restoration Processing

In the following, a specific example of the crash restoration processing will be described according to the second embodiment. It is assumed that the configuration of the disk array 1 and the storage devices in the crash restoration processing is also the same as the configuration shown in FIG. 13. In the following, the operations performed according to the capacity of the substitute storage device (not shown), which is inserted at the time of crash of the storage device 2b (400 GB) having the second smallest capacity among the storage devices configuring the disk array 1, will be described, respectively.

In the disk array 1, the configuration drive management function 131 compares the capacity of the substitute storage device with the capacity of the existing storage devices 2a, 2c and 2d, and with the capacity of the crashed storage device 2b (S122).

<Case of Insertion of Substitute Storage Device Having Capacity Smaller than Capacity of Crashed Storage Device 2b (400 GB)>

The configuration drive management function 131 determines that the disk array 1 cannot be restored, and stops the restoration processing (S123 and S1213).

<Case of Insertion of Substitute Storage Device Having Capacity not Smaller than Capacity of Crashed Storage Device 2b (400 GB) and Smaller than Capacity of Storage Device 2c (600 GB)>

The parity management function 134 restores the contents of the crashed storage device 2b in the substitute storage device on the basis of the parity bits and the data information which are stored in the existing storage devices 2a, 2c and 2d.

<Case of Insertion of Substitute Storage Device Having Capacity not Smaller than Capacity of Storage Device 2c (600 GB) and Smaller than Capacity of Storage Device 2D (2 TB)>

The configuration drive management function 131 copies the contents of the existing storage device 2c into the substitute storage device. This processing is performed to secure the consistency in the capacity and the stripe structure length Si between the storage devices 2, and has the effect of optimizing the performance of the disk array 1.

After the copy processing, the parity management function 134 restores the contents of the crashed storage device 2b in the storage device 2c on the basis of the parity bits and the data information which are stored in the existing storage devices 2a and 2d, and in the substitute storage device (in which the same contents as those of the storage device 2c are stored).

<Case of Insertion of Substitute Storage Device Having Capacity not Smaller than Capacity of Storage Device 2d (2 TB)>

Also in this case, the copying of the existing storage device is performed in order to maintain the consistency in the capacity and the stripe structure length Si between the storage devices 2.

First, the configuration drive management function 131 copies the contents of the existing storage device 2d into the substitute storage device. After the copy processing, the configuration drive management function 131 copies the contents of the existing storage device 2c into the existing storage device 2d. The previous copy processing (2d to the substitute storage device) does not necessarily need to be ended before this copy processing (2c to 2d). When the disk array 1 is provided with the communication bus 15 having a sufficient capacity, the two copy processing may be performed in parallel. When the parallel processing is performed, the time required for the data restoration procedure can be reduced.

At the time when both the copy processing is completed, the parity management function 134 restores the contents of the crashed storage device 2b into the existing storage device 2c by using the parity bits and the data information which are stored in the existing storage devices 2a and 2d (having contents of the storage device 2c), and in the substitute storage device (having contents of the storage device 2d).

With the above described operations, it is possible to provide a disk array 1 which is configured by storage devices having a different capacity and which has a function to restore data while optimizing its performance.

### (5) Summary

In the disk array of each of the embodiments, the data management section manages a source data by dividing the source data into a plurality of stripe structure data, and by distributing and storing the plurality of stripe structure data in a plurality of storage devices. Here, among the plurality of storage devices, at least one storage device has a capacity different from the capacity of the other storage devices. The data management section performs control for determining the length of stripe structure data according to the capacity of each of the plurality of storage devices, and for storing the stripe structure data of the same length in the each of the storage devices (see FIG. 2 and FIG. 8). With this configuration, it is possible to efficiently use the capacity of each of the storage devices without the influence of the storage device having the smallest capacity. That is, since the capacity of the storage device can be freely selected, it is possible to suppress the cost at the time of constructing the system (storage system) which is configured by a disk array and a storage device.

When receiving an access request from the host apparatus (in the case of RAID 0), the data management section first calculates the head chunk structure, which is the chunk structure including the position of request LBA, by dividing the request LBA (LBA in the virtual disk space), which is included in the access request, by the length of chunk structure. Then, on the basis of the request LBA, the head chunk structure, the information on the length of the stripe structure data, which information is included in the head chunk structure, the data management section calculates the offset which is the distance from the starting position of the head chunk structure to the request LBA, so as to specify the storage device (access start storage device) which is to start to be accessed. Further, the data management section specifies the access start LBA (LBA in the real disk space) in the access start storage device on the basis of the head chunk structure position information indicating the ordinal number of the head chunk structure in the chunk structures, and the offset. Thereby, it is possible to access to desired data at high speed even when the stripe structure length of each of the storage devices is different.

In the case of RAID 5, the data management section manages a set of the stripe structure data as a chunk structure, and performs control for: determining the storage device in charge of storing parity bits (storage device in charge of parity bits) on the basis of the information indicating the ordinal number of the target chunk structure in the order of the chunk structures; generating parity bits (whose length is set equal to the length of the stripe structure data in the storage device having the largest capacity) by using the stripe structure data of the storage devices other than the storage device in charge of parity bits; storing only the parity bits in the storage device in charge of parity bits; and for storing, in each of the storage devices other than the storage device in charge of parity bits, the stripe structure data, the length of which is determined according to the capacity of the each of the storage devices. Thereby, it is possible, while corresponding to RAID 5, to efficiently use the capacity of each of the storage devices without the influence of the storage device having the smallest capacity.

At this time, when the process, in which each of the plurality of storage devices becomes in charge of parity bits once, is set as one cycle, the data management section performs management such that the total length of the stripe structure data other than the parity bits in all the chunk structures included in one cycle is configured to be equal between the cycles. When the data are managed in this way, it is possible to realize high-speed access performance.

More specifically, when receiving an access request from the host apparatus (in the case of RAID 5), the data management section first calculates the ordinal number of the cycle corresponding to the position of the request LBA by dividing the request LBA (LBA in the virtual disk space), which is included in the access request, by the total length of the stripe structure data in all the chunk structures included in one cycle. Then, the data management section calculates a first offset that is a distance from the head of the corresponding cycle to the request LBA. Further, on the basis of the first offset and the length information of each of the chunk structures included in the corresponding cycle, the data management section specifies the head chunk structure which is the chunk structure including the position of the request LBA. Further, on the basis of the request LBA, the head chunk structure, and the length information of the stripe structure data included in the head chunk structure, the data management section calculates a second offset which is a distance from the starting position of the head chunk structure to the request LBA, and specifies the storage device (access start storage device) which is to start to be accessed. Finally, the data management section specifies the access start LBA (LBA in the real disk space) in the access start storage device on the basis of the head chunk structure position information indicating the ordinal number of the head chunk structure in the order of the chunk structures, the information on the access start storage device, the stripe structure data length of the access start storage device, and the information on the number of times when the access start storage device has been in charge of parity bits. Since the access start LBA is specified by the above operations, it is possible to realize desired access performance without using a complicated algorithm.

Further, when among the plurality of storage devices, at least one storage device (storage device to be substituted, for example, a crashed storage device) is replaced by a substitute storage device having a capacity larger than the capacity of the storage device to be substituted, the data management section stores the data of the storage device to be substituted in the substitute storage device. In this case, the data management section restores the data of the storage device to be substituted (crashed storage device) from the data stored in the storage devices other than the storage device to be substituted, and stores the restored data in the substitute storage device. Further, when other than the storage device to be substituted, there are storage devices (existing storage devices) having a capacity smaller than the capacity of the substitute storage device, the data management section successively copies the data of the existing storage device having the capacity smaller than and closest to the capacity of the substitute storage device, into the substitute storage device, and copies the data of the storage device to be substituted into the existing storage device having the capacity lager than and closest to the capacity of the storage device to be substituted. Thereby, it is possible to replace the crashed storage device while the capacity of the substitute storage device is maximally utilized. That is, when the data of the storage device to be substituted is only stored in the substitute storage device in spite of the fact that there is an existing storage device having a capacity smaller than the capacity of the substitute storage device, a large amount of free space (free space which is not subsequently used) exists in the substitute storage device. Thus, when an existing storage device having a capacity smaller than the capacity of the substitute storage device exists, the data of the storage device to be substituted is made to be stored in the existing storage device having the smallest capacity among the existing storage devices having the capacity larger than the capacity of the storage device to be substituted. Further, the data of the existing storage device are stored in the other existing storage device having a larger capacity or in the substitute storage device, and thereby it is possible to efficiently use the capacity of the storage devices.

Note that the present invention can also be realized by a program code of software which realizes the functions of the embodiments. In this case, a storage medium in which the program code is recorded is provided in a system or a device, and a computer (or CPU and MPU) of the system or the device reads the program code stored in the storage medium. In this case, the program code itself read from the storage medium realizes the above described functions of the embodiments, and hence the program code itself and the storage medium storing the program code constitute the present invention. As the storage medium for supplying such program code, for example, a flexible disk, CD-ROM, DVD-ROM, a hard disk drive, an optical disk, a magneto-optical disk, CD-R, magnetic tape, a nonvolatile memory card, ROM, and the like, are used.

Further, it may also be configured such that, on the basis of the instruction of the program code, a part of or all of the actual processing is performed by the OS (operating system), or the like, operated on the computer, and such that the above described functions of the embodiments are realized by the processing. Further, it may also be configured such that, after the program code read from the storage medium is written in the memory of the computer, a part of or all of the actual processing is performed by the CPU, or the like, of the computer on the basis of the instruction of the program code, and such that the above described functions of the embodiments are realized by the processing.

Further, it may also be configured such that the program code of the software, which realizes the functions of the embodiments, is distributed via a network so as to be stored in a storage device, such as a hard disk drive and a memory, of a system or an apparatus, or so as to be stored in a storage medium, such as a CD-RW and a CD-R, and such that at the time of use, the computer (or CPU and MPU) of the system or the apparatus reads the program code stored in the storage device and the storage medium and executes the read program code.

What is claimed is:

1. A disk array comprising:
a reception section which receives a source data from a host apparatus; and
a data management section which divides the source data into a plurality of stripe structure data so as to distribute and store the plurality of stripe structure data in a plurality of storage devices,
wherein at least one of the storage devices has a capacity different from the capacity of the other storage devices, and
wherein the data management section performs control for determining the length of the stripe structure data according to the capacity of each of the plurality of storage devices, and storing the stripe structure data of the same length in the each of the storage devices.

2. The disk array according to claim 1,
wherein the data management section manages, as a chunk structure, a data set configured by each one of the stripe structure data respectively stored in the plurality of storage devices, and
wherein the source data is configured by a set of the chunk structures.

3. The disk array according to claim 2,
wherein when an access request from the host apparatus is received by the reception section,
the data management section performs processing of:
dividing a request LBA (LBA in the virtual disk space) included in the access request by the length of the chunk structure, and thereby calculating a head chunk structure which is the chunk structure including the position of the request LBA;
calculating an offset, which is a distance from the starting position of the head chunk structure to the request LBA, on the basis of the request LBA, the head chunk structure, and the information on the length of the stripe structure data, which information is included in the head chunk structure, and thereby specifying a storage device (access start storage device) which is to start to be accessed; and
specifying an access start LBA (LBA in the real disk space) in the access start storage device on the basis of the head chunk structure position information indicating the ordinal number of the head chunk structure in the order of the chunk structures, and the offset.

4. The disk array according to claim 1,
wherein the data management section manages a set of the stripe structure data as a chunk structure, and performs control for: determining a storage device in charge of storing parity bits (storage device in charge of parity bits) on the basis of information on the ordinal number of a target chunk structure in the order of the chunk structures; generating parity bits on the basis of the stripe structure data of the storage devices other than the storage device in charge of parity bits; storing only the generated parity bits in the storage device in charge of parity bits; and storing the stripe structure data, the length of which is determined according to the capacity of each of the storage devices other than the storage device in charge of parity bits, in the each of the storage devices.

5. The disk array according to claim 4,
wherein when the process, in which each of the plurality of storage devices becomes in charge of storing the parity bits once, is set as one cycle, the data management section performs management so that the total length of the stripe structure data other than the parity bits in all the chunk structures included in one cycle is configured to be the same between the cycles.

6. The disk array according to claim 5,
wherein when an access request from the host apparatus is received by the reception section,
the data management section performs processing of:
dividing the request LBA (LBA in the virtual disk space) included in the access request by the total length of the stripe structure data in all the chunk structures included in the one cycle, and thereby calculating the ordinal number of the cycle corresponding to the position of the request LBA;
calculating a first offset which is a distance from the head of the corresponding cycle to the request LBA;
specifying a head chunk structure, which is the chunk structure including the position of the request LBA, on the basis of the first offset and the length information of each of the chunk structures, which information is included in the corresponding cycle;
calculating, on the basis of the request LBA, the head chunk structure, and the length information of the stripe structure data, which information is included in the head chunk structure, a second offset which is a distance from the starting position of the head chunk structure to the request LBA, and thereby specifying a storage device (access start storage device) which is to start to be accessed; and
specifying an access start LBA (LBA in the real disk space) in the access start storage device on the basis of the chunk structure position information indicating the ordinal number of the head chunk structure in the order of the chunk structures, the information on the access start storage device, the stripe structure data length of the access start storage device, and the information on the number of times when the access start storage device has been in charge of storing the parity bits.

7. The disk array according to claim 1,
wherein when at least one of the storage devices (storage device to be substituted) is replaced by a substitute storage device having a capacity larger than the capacity of the storage device to be substituted,
the data management section stores the data of the storage device to be substituted in the substitute storage device.

8. The disk array according to claim 7,
wherein the data management section restores the data of the storage device to be substituted, on the basis of the data stored in the storage devices other than the storage device to be substituted, and stores the restored data in the substitute storage device.

9. The disk array according to claim 7,
wherein when among the storage devices (existing storage devices) other than the storage device to be substituted, there are storage devices having a capacity smaller than the capacity of the substitute storage device, the data management section successively copies the data of the existing storage device having the capacity smaller than and closest to the capacity of the substitute storage device, into the substitute storage device, and then stores the data of the storage device to be substituted into the existing storage device having the capacity larger than and closest to the capacity of the storage device to be substituted.

10. A control method of a disk array to which a plurality of storage devices are attached, which includes a reception section and a data management section, and in which at least one of the plurality of storage devices has a capacity different from the capacity of the other storage devices,
the control method comprising:
a reception step of receiving source data from a host apparatus; and
a storage step in which the data management section divides the source data into a plurality of stripe structure data, and distributes and stores the plurality of stripe structure data in the plurality of storage devices,
wherein in the storage step, the data management section performs control for determining the length of the stripe structure data according to the capacity of each of the plurality of storage devices, and for storing the stripe structure data of the same length in the each of the storage devices.

11. A program for operating a computer as the disk array according to claim 1.
